(19) United States
(12) Patent Application Publication
(10) Pub. No.: US 2004/0154461 A1
(43) Pub. Date: Aug. 12, 2004

(54) Methods and apparatus providing group playing ability for creating a shared sound environment with MIDI-enabled mobile stations

(75) Inventors: Kai Havukainen, Tampere (FI); Jukka Holm, Tampere (FI); Pauli Laine, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/360,215

(22) Filed: Feb. 7, 2003

(51) Int. Cl. G10H 7/00

(52) U.S. Cl. 84/645

(57) ABSTRACT

A method is disclosed for operating two or more mobile stations that form a local group. The method includes beginning an application, such as a game that transfers data, with each of the mobile stations; and using a variation in sound made by each of the mobile stations to represent movement of a virtual object, such as a game piece, between the station. The variation in sound can be caused by execution of MIDI commands that change the volume and/or the pitch of the sound, and can be made in response to MIDI commands from another mobile station designated as the group master. The sound may be separately varied to represent both horizontal and vertical changes in object motion. Also disclosed is a mobile station having an audio user interface (AUI) for representing motion of a data object relative to the mobile station by varying an audio output.

### TECHNICAL FIELD

These teachings relate generally to wireless communications systems and methods and, more particularly, relate to techniques for operating a plurality of mobile stations, such as cellular telephones, when playing together in a Musical Instrument Digital Interface (MIDI) environment.

### BACKGROUND

A standard protocol for the storage and transmission of sound information is the MIDI (Musical Instrument Digital Interface) system, specified by the MIDI Manufacturers Association. The invention is discussed in the context of MIDI for convenience because that is a well known, commercially available standard. Other standards could be used instead, and the invention is not confined to MIDI.

The information exchanged between two MIDI devices is musical in nature. MIDI information informs a music synthesizer, in a most basic mode, when to start and stop playing a specific note. Other information includes, e.g. the volume and modulation of the note, if any. MIDI information can also be more hardware specific. It can inform a synthesizer to change sounds, master volume, modulation devices, and how to receive information. MIDI information can also be used to indicate the starting and stopping points of a song or the metric position within a song. Other applications include using the interface between computers and synthesizers to edit and store sound information for the synthesizer on the computer.

The basis for MIDI communication is the byte, and each MIDI command has a specific byte sequence. The first byte of the MIDI command is the status byte, which informs the MIDI device of the function to perform. Encoded in the status byte is the MIDI channel. MIDI operates on 16 different channels, numbered 1 through 16. MIDI units operate to accept or ignore a status byte depending on what channel the unit is set to receive. Only the status byte has the MIDI channel number encoded, and all other bytes are assumed to be on the channel indicated by the status byte until another status byte is received.

A Network Musical Performance (NMP) occurs when a group of musicians, each of whom may be located at different physical location, interact over a network to perform as they would if located in the same room. Reference in this regard can be had to a publication entitled “A Case for Network Musical Performance”, J. Lazzaro and J. Wawrzynek, NOSSDAV'01, Jun. 25-26, 2001, Port Jefferson, N.Y., USA. These authors describe the use of a client/server architecture employing the IETF Real Time Protocol (RTP) to exchange audio streams by packet transmissions over a network. Related to this publication is another publication: “The MIDI Wire Protocol Packetization (MWPP)”, also by J. Lazzaro and J. Wawrzynek, (see http://www.ietf.org).

General MIDI (GM) is a wide spread specification family intended primarily for consumer quality synthesizers and sound cards. Currently there exist two specifications: GM 1.0, “General MIDI Level 1.0”, MIDI Manufacturers Association, 1996, and GM 2.0, “General MIDI Level 2.0”, MIDI Manufacturers Association, 1999. Unfortunately, these specifications require the use of high polyphony (24 and 32), as well as strenuous sound bank requirements, making them less than optimum for use in low cost cellular telephones and other mobile stations.

In order to overcome these problems, the MIDI Manufacturers Association has established a Scalable MIDI working group that has formulated a specification, referred to as SP-MIDI, that has become an international third generation (3G) standard for mobile communications. In order to have the most accurate references, this application will quote from the specification from time to time. SP-MIDI's polyphony and sound bank implementations are scalable, which makes the format better suited for use in mobile phones, PDAs and other similar devices. Reference with regard to SP-MIDI can be found at www.midi.org., more specifically in a document entitled “Scalable Polyphony MIDI Specification and Device Profiles”, and is incorporated by reference herein.

With the foregoing state of the art in mind, it is noted that in a typical multi-channel sound system there are a plurality of speakers, and the location and movement of sound is based on well known panning concepts. In most cases the number and locations of the speakers is fixed. For example, when listening to stereo and surround sound systems there are two or more speakers present that are located at fixed positions, and a single audio control unit operates all of the speakers.

In multi-player gaming applications the players can be located in different rooms (or even different countries and continents), and each player has his own sound system. In these cases it is often desirable that the users do not share the sounds, as each user's game playing equipment (e.g., PCs) will typically have independent (non-shared) sound and musical effects.

However, there are other gaining applications where the players can be located in the same physical space. As such, the conventional techniques for providing sound can be less than adequate for use in these applications.

A need thus exists for new ways to provide and control the generation of sounds in multi-user game playing and other multi-user applications.

In addition, the prior art has been limited in ways of representing the position of objects in multi-user applications. Graphical indicators have traditionally been used to express, for example, the current status when transferring or copying data from one digital device to another.

In general, the conventional user interface for a digital device has been based on the graphical user interface (GUI) using some type of visual display. However, the visual displays used in desktop computers are typically large in order to present a great deal of detail, and thus are not well suited for use in portable, low power and low cost digital device applications such as those found in cellular telephones, personal communicators and personal digital assistants (PDAs).

As such, a need also exits for providing new and improved user interfaces for use in small, portable devices such as, but not limited to, cellular telephones, personal communicators and PDAs.

### SUMMARY OF THE PREFERRED EMBODIMENTS

The foregoing and other problems are overcome, and other advantages are realized, in accordance with the presently preferred embodiments of these teachings. A method is herewith provided to allocate and partition the playing of music and the generation of non-musical sounds between two or more mobile stations.

The teachings of this invention provide in one aspect an entertainment application utilizing the sound-producing capabilities of multiple mobile stations in a coordinated and synchronized fashion, with localized control over the sound generation residing in each of the mobile stations.

The teachings of this invention provide in another aspect an improved user interface application utilizing the sound-producing capabilities of multiple mobile stations in a coordinated and synchronized fashion, with localized control over the sound generation residing in each of the mobile stations.

This invention combines the sounds of multiple mobile stations into one shared sound environment, and enables new ways of gaming and communicating. An aspect of this invention is that the shared sound environment may function as a user interface, in this case an audio user interface (AUI), as opposed to the conventional graphical user interface (GUI). A combination of the AUI and the GUI can also be realized, providing an enhanced user experience.

The mobile stations are assumed to be synchronized to one another using, for example, a low power RF interface such as Bluetooth, and the mobile stations play the same data according to specified rules.

A method is disclosed for operating at least two mobile stations that form a local group of mobile stations. The method includes (a) beginning an application with each of the mobile stations and (b) using a variation in sound made by each of the mobile stations to represent a virtual object that moves between the mobile stations during execution of the application. The application may be a game, and the virtual object represents a game piece. The application may be one that transfers data, and the virtual object represents the data. The variation in sound can be caused by execution of MIDI commands that change in a linear manner or in a non-linear manner the volume and/or the pitch of the sound made by the mobile stations.

The step of beginning the application can include a step of assigning a unique identifier to each of the mobile stations during an application enrollment step. As one example, the unique identifier can correspond to a MIDI channel number. Preferably one of the at least two mobile stations functions as a group master, and assigns an identification within the group to other mobile stations using an electronic link such as a local network (wireless or cable).

The variation in sound in one of the mobile stations can be made in response to MIDI commands received through a wireless interface from another mobile station, such as one designated as the group master.

In one embodiment the motion of the virtual object has both a horizontal component and a vertical component, and the sound is separately varied to represent changes in object motion in both the horizontal and vertical components.

Also disclosed is a mobile station having an audio user interface (AUI) for representing to a user a motion of a data object relative to the mobile station, the motion being represented by a variation in an audio output of the mobile station.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a high level block diagram showing a wireless communication network comprised of a plurality of MIDI devices, such as one or more sources and one or more MIDI units, such as a synthesizer;

FIG. 2 illustrates a block level diagram of a mobile station;

FIG. 3 is a simplified block diagram in accordance with this invention showing two of the sources from FIG. 1 that are MIDI enabled;

FIG. 4 is an exemplary state diagram illustrating the setting of IDs when one device acts as a master device;

FIG. 5 illustrates an example of the use of shared sound for moving an object from a first to a second mobile station; and

FIG. 6 illustrates an example of the use of shared sound for representing object movement from the first to the second mobile station.

### DETAILED DESCRIPTION OF THE PREFERRED EMBODIMENTS

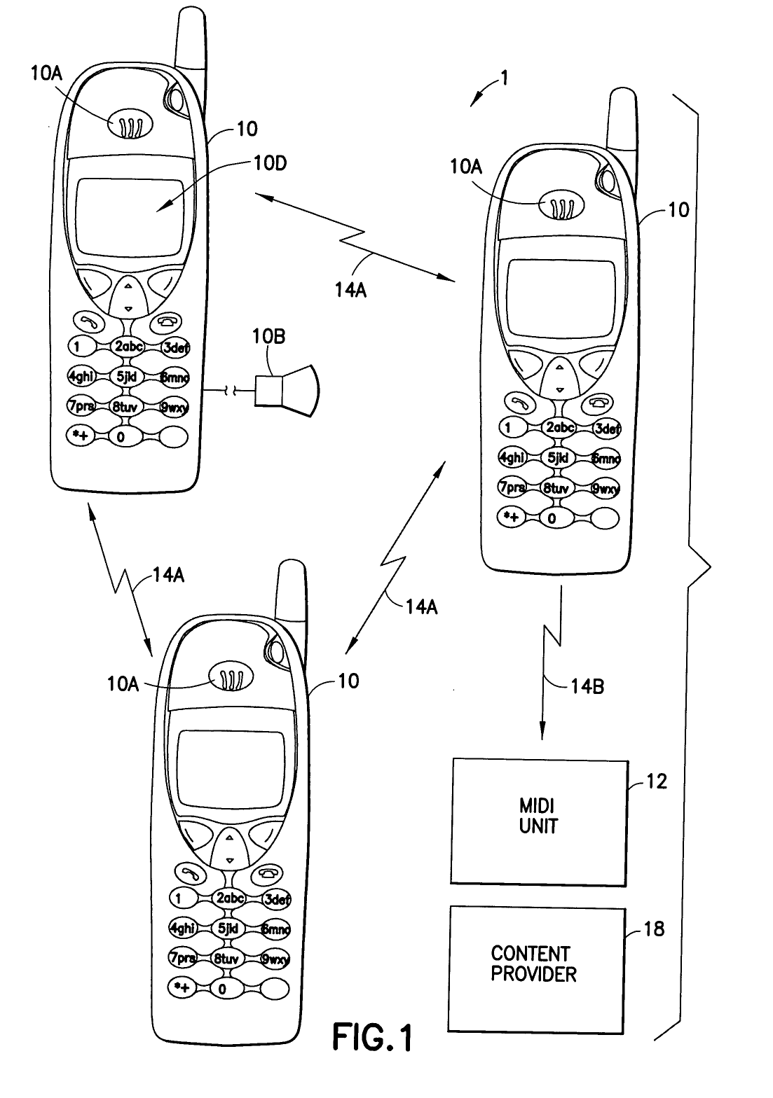

FIG. 1 shows a wireless communication network 1 that includes a plurality of MIDI devices, such as one or more mobile telephone apparatus (handsets) 10, and one or more MIDI units 12. The MIDI unit 12 could be or could contain a music synthesizer, a computer, or any device that has MIDI capability. Illustratively, handsets 10 will contain a chip and/or associated software that performs the tasks of synthesis. The sources 10 could include headphones (not shown), but preferably for a group playing session as envisioned herein, a speaker such as the internal speaker 10A or an external speaker 10B, is used for playing music. Wireless links are assumed to exist between the MIDI devices, and may include one or more bi-directional (two way) links 14A and one or more uni-directional (one way) links 14B. The wireless links 14A, 14B could be low power RF links (e.g., those provided by Bluetooth hardware), or they could be IR links provided by suitable LEDs and corresponding detectors. Box 18, labeled Content Provider, represents a source of MIDI files to be processed by the inventive system. Files may be transferred through any convenient method, e.g. over the Internet, over the telephone system, through floppy disks, CDs, etc. In one particular application, the data could be transmitted in real time over the internet and played as it is received. One station could receive the file and transmit it, in whole or only in relevant parts, over the wireless link 14A, 14B, or the phone system to the others. Alternatively, the file could be received at any convenient time and stored in one or more stations.

The above mentioned SP-MIDI specification presents a music data format for the flexible presentation of MIDI for a wide range of playback devices. The specification is directed primarily to mobile phones, PDAs, palm-top computers and other personal appliances that operate in an environment where users can create, purchase and exchange MIDI music with devices that have diverse MIDI playback capabilities.

SP-MIDI provides a standardized solution for scalable playback and exchange of MIDI content. The Scalable Polyphony MIDI Device 5-24 Note Profile for 3GPP describes a minimum required sound set, sound locations, percussion note mapping, etc., thereby defining a given set of capabilities for devices capable of playing 5-24 voices simultaneously (5-24 polyphony devices).

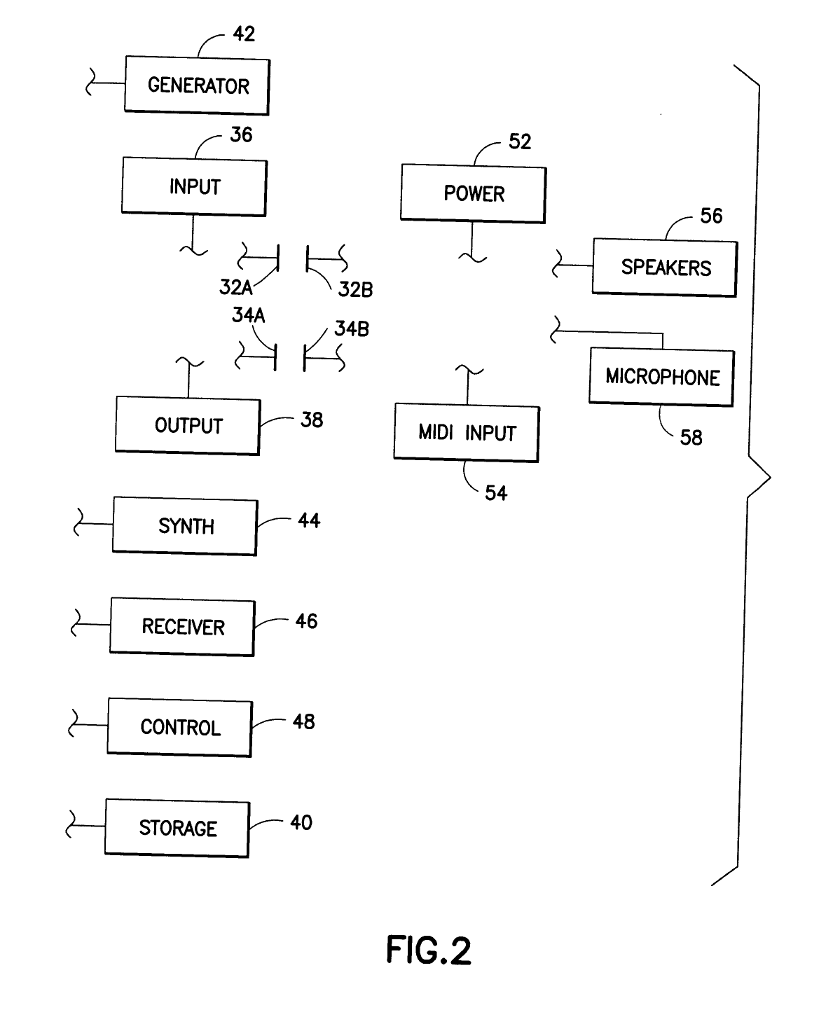

Referring now to FIG. 2, there is shown a block diagram level representation of a station according to the invention. On the right, units exterior to the station are displayed —speakers 56, microphone 58, power supply (or batteries) 52 and MIDI input device 54. The power supply may be connected only to the external speakers 56, to the other exterior units, or to the station itself. The MIDI input device may be a keyboard, drum machine, etc. On the left of the Figure, a line of boxes represent various functions and the hardware and/or software to implement them. In the center, connectors 32A and 32B and 34A and 34B represent any suitable connector that may be used in the invention to connect a standard mobile station to external devices without adding an additional connector (e.g., a microphone-earpiece headset). At the bottom left, Storage 40 represents memory (e.g., floppy disks, hard disks, etc.) for storing data. Control 48 represents a general purpose CPU, micro-controller, etc. for operating the various components according to the invention. Receiver 40 represents various devices for receiving signals (e.g., the local RF link discussed above, telephone signals from the local phone company, signal packets from the Internet, etc.). Synthesizer 44 represents a MIDI or other synthesizer. Output 38 represents switches (e.g., mechanical or solid state) to connect various units to the output connector(s). Similarly, input 36 represents switches (e.g., mechanical or solid state) to connect various units to the input connector(s) as well as analog to digital converters to convert microphone input to signals compatible with the system, as described below. Generator 42 represents devices to generate signals to be processed by the system (e.g., an accelerometer to be used to convert shaking motions by the user to signals that can control the synthesizer to produce maraca or other percussion sounds, or the keypad of the mobile station). Those skilled in the art will be aware that there is flexibility in block diagram representation and one physical unit may perform more than one of the functions listed above; or a function may be performed by more than one unit cooperating.

This invention provides for grouping several devices together to create a sound world or sound environment that is common to all of the devices. The devices are assumed for the ensuing discussion to be mobile stations 10, as shown in FIG. 1 and are referred to below as mobile stations 10. However, the devices could include one or more MIDI units 12, as discussed above. The devices could also include one or more PDAs, or any other type of computer or portable digital device having some type of wireless communication capability with other members of the group of devices, and some means for making sound, typically embodied as a small, self-contained speaker or some other type of audio output transducer.

Each mobile station 10 is assumed to have at least one user associated therewith, although one user could be associated with two or more of the mobile stations 10. The mobile stations 10 are preferably located in the same physical space such that the users can hear the sound generated by all of the mobile stations. Each mobile station 10 is assigned a unique group identification (ID) by which it can be differentiated from the other mobile stations 10 in the group. Each mobile station 10 is assumed, as was noted above, to have at least one speaker attached, such as the internal speaker 10A discussed in reference to FIG. 1.

The audio behavior of the mobile stations 10 depends both on the actions of the associated user and on the actions of other users in the group. This principle enables, for example, “playing” together in a group having at least one member who can vary the sound output of his station, e.g. by playing drum music through it; and a controlled interaction between multiple mobile stations, e.g. the “moving” of objects from one mobile station 10 to another.

This controlled interaction between mobile stations 10 enables the playing of multi-participant games, as will be described below. Assuming that the devices are small, e.g., cellular telephones and personal communicators, they and their associated speaker(s) can easily be moved about, unlike conventional multi-channel sound systems.

The number of participating mobile stations is not fixed. Each mobile station 10 is assigned a unique ID, using which it can be differentiated from the other mobile stations in the group. The ID could be one that is already associated with the mobile station 10 when it is used in the cellular telecommunications network, or the ID could be one assigned only for the purposes of this invention, and not otherwise used for other mobile station 10 functions or applications.

Assuming that the mobile stations 10 are small and portable, they can easily be carried about and moved during use, so long as the range of audibility and synchronization can be maintained. Overall control of the system or group of mobile stations 10 can be divided between all of the mobile stations. In this case the audio behavior of the mobile stations 10 depends both on their own users' actions, and on the actions performed by other users. Alternatively, one mobile station 10 can function as a master or leader of the group. The master mobile station 10 has more control over the shared sound environment than the other members of the group and may, for example, be responsible for assigning IDs to each participating mobile station 10.

The shared sound environment made possible by the teachings of this invention enables, for example, the “moving” of objects from one mobile station 10 to another. Examples of this kind of application include, for example, the playing of multi-participant games such as volleyball and spin-the-bottle. By changing the relative volume of the sound produced by two mobile stations 10 the sound can be made to appear as if it is traveling from one mobile station 10 to another. However, as each mobile station 10 has a unique ID, the movement can occur between any two random mobile stations 10 of the group regardless of their locations.

When several mobile stations 10 are used to create the shared sound environment, each of them is uniquely identified so as to be able to resolve which mobile station 10 has a turn, how the sound should be moved in space, and so forth. The identification of mobile stations 10 can be accomplished, for example, using either of the following methods.

In a first embodiment, some group member's mobile station 10 acts as the master mobile station 10 and assigns an ID to each mobile station 10 as it joins the group. The IDs can be assigned in the joining order or at random.

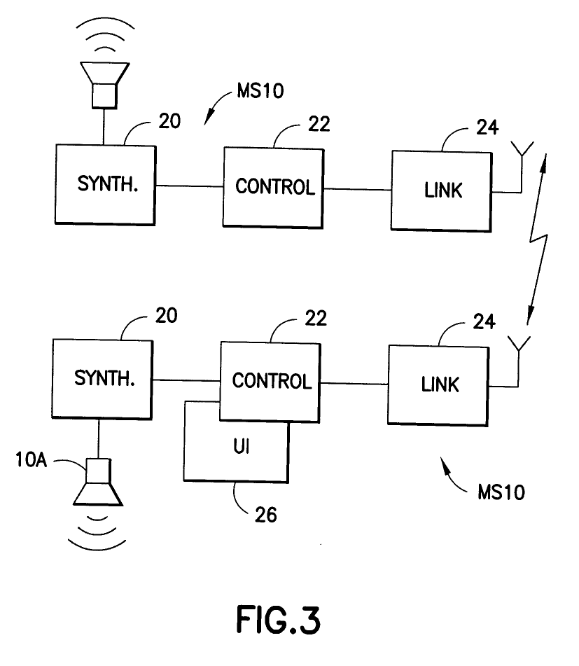

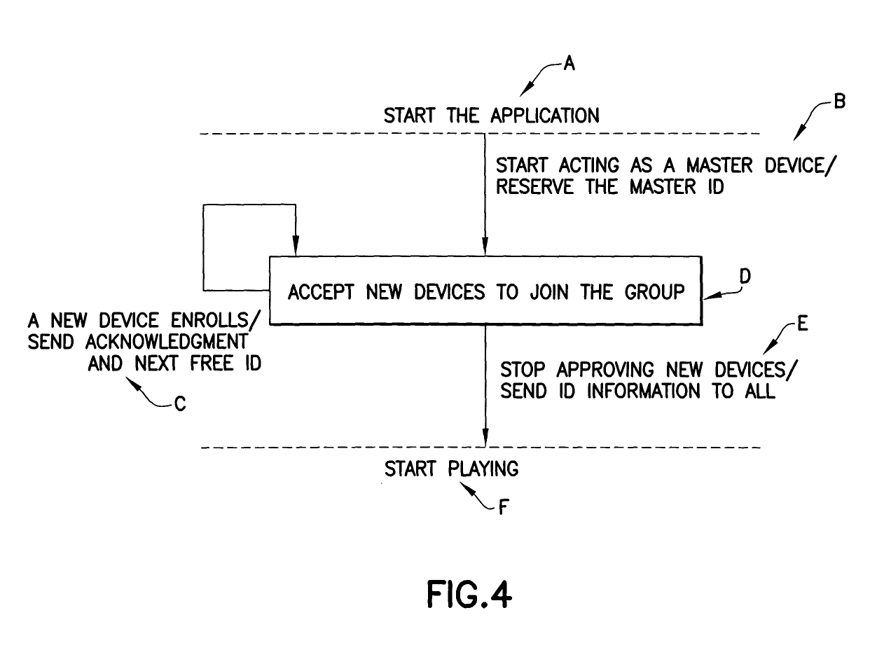

FIG. 4 shows an example of starting an application and assigning the IDs to various ones of the mobile stations 10 of the group. At Step A the shared sound environment application is begun, and at Step B one of the mobile stations 10 assumes the role of the master device and reserves a master device ID. As examples, this mobile station 10 could be the first one to join the group, or one selected by the users through the user interface (UI) 26 (See FIG. 3). As other mobile stations 10 enter the space occupied by the group (e.g., a space defined by the reliable transmission range of the wireless link 24, that is also small enough for the sound from all devices to be heard by all participating mobile stations 10, the new device attempts to enroll or register with the group (Step C). If accepted by the master device an acknowledgment is sent, as well as the new mobile stations group ID (Step D). At some point, if playing has not yet begun, the group is declared to be full or complete (Step E), and at Step F the group begins playing the shared sound audio.

In a second embodiment, the unique serial number of each mobile station 10 is used for the group ID. Note that the MIDI format can also be used to identify mobile stations 10 by assigning, for example, one of the 16 different MIDI channels to each different mobile station 10. Notes of different pitch and control messages can also be used to control the mobile stations 10.

FIG. 5 is an example of the use of shared sound to represent the movement of an “object” from one mobile station 10 towards another. The object may be a game piece, such as a virtual ball or a spinning pointer, or it may be a data file, including an electronic message or an entry in an electronic address book, or it may in general be any organization of data that is capable of being transferred from one mobile station 10 to the other in a wireless manner. The data could also be a number or code, such as a credit card number, that is used in an electronic commerce transaction, and in this case the changing sound can be used to inform the user of the mobile station 10 of the progress of the transaction (e.g., transfer of the code to another mobile station or to some other receiver or terminal, transfer back of an acknowledgment, etc.)

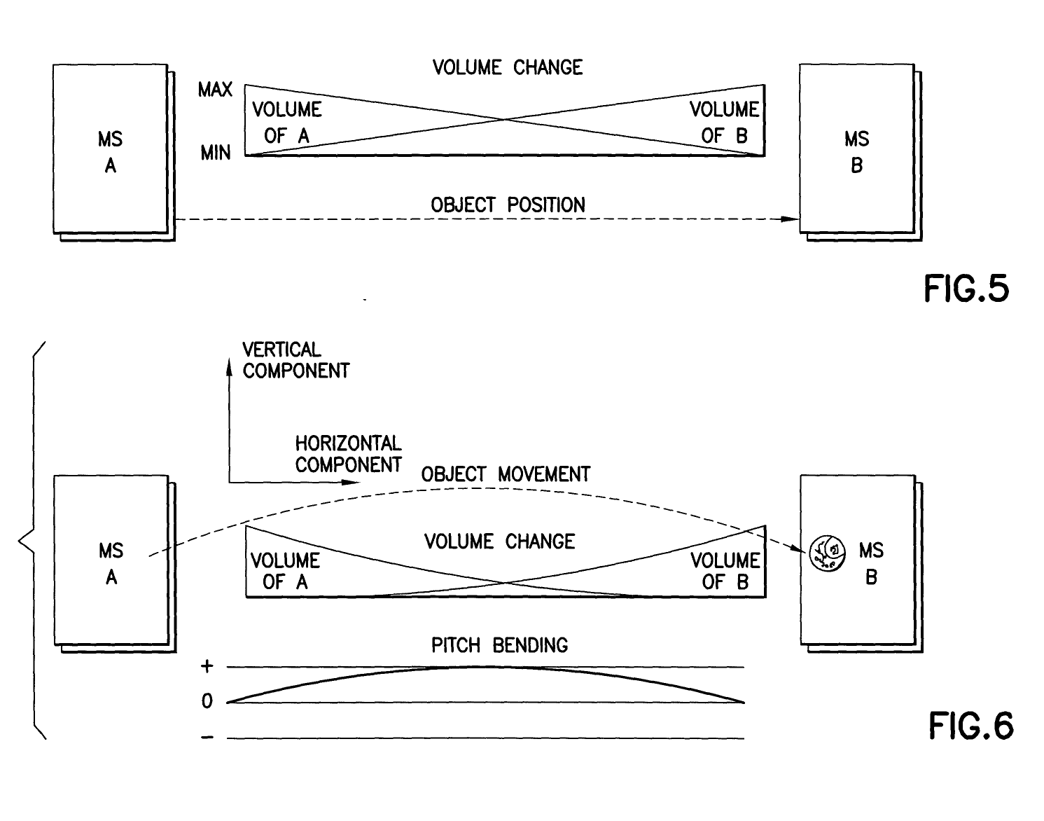

In the examples of FIGS. 5 and 6, assume the mobile station A (MS_A) is the source of the “object” and mobile station B (MS_B) is the destination. In FIG. 5, the volume level of the sound at the destination mobile station 10 (MS_B) increases while the volume of the sound fades out at the source mobile station 10 (MS_A), producing the impression in listeners that an object making the sound is moving from station A to station B. When the object is virtually located at one of the mobile stations 10 (MS_A or MS_B), the sound representing the object is played only by that mobile station 10.

The sound representing the object is preferably the same in both the sending and receiving mobile stations 10. This can be readily accomplished by employing the same MI DI Program Change message to select the instruments in MS_A and MS_B.

FIG. 6 also shows an embodiment where the object is moved horizontally from MS_A to MS_B, using the same technique of simultaneously changing volumes in the two stations. The representation of movement can also be expressed by triggering sounds of changing volumes repetitively, as opposed to sliding the volume of a single sound. FIG. 6 also shows that the sound volume transition need not be linear, as was shown in FIG. 5. This is true since the acoustic characteristics of different mobile stations 10, may vary considerably, and different sound transitions may be suitable for different applications. Also the timbres of instruments affect how the transition is heard.

Some amount of vertical movement may also be applied to the object. For example, the are of a “thrown” object, such as the dotted line and ball of FIG. 6, can be expressed by adding a pitch change to the sound, in addition to the sound volume change. In this example the sound is played at its original pitch when the object is stationary and located at the source or destination mobile station 10. After the object is thrown by MS_A, the pitch of the sound is shifted upwards until the object reaches the highest point in its virtual trajectory (e.g., the dotted line of FIG. 6). As object then begins to descend, the pitch of the sound is shifted back downwards until it has returned to the original pitch when “caught” by MS_B. The pitch can change in a non-linear manner, as shown in the lower portion of FIG. 6, or in a linear manner.

Other embodiments for moving the object either horizontally or vertically include applying filtering to the sound to simulate a desired effect, the use of different musical notes, and so forth.

As an example of the use of this invention, consider a game of spin-the-bottle, which can be a useful way of selecting one member of a group. When multiple mobile stations 10 are synchronized and located near to one another, sound can be used to illustrate the direction in which the bottleneck points. In this example one of the group members launches the spin-the-bottle application of their mobile station 10, and others join the application using their own mobile stations. When the members of the group have enrolled and been assigned their IDs (see FIG. 4), the first member launches the rotation of the bottle through their UI 26. In response, the mobile station 10 control unit 22 causes the sound to move in a specific or a random order between mobile stations 10, first at a fast rate, then at a gradually slowing rate until the sound is played by only one of the mobile stations 10 of the group. As an example, if the sound moves from one mobile station 10 to another in the order of enrollment into the group, a conventional game of rotating spin-the-bottle can be played by the users sitting in a ring in the enrollment order. In this embodiment the object that moves between the mobile stations 10 represents the neck of the virtual spinning bottle.

Games such as ping-pong and tennis have previously been implemented for mobile stations, but they have been very strongly constrained by the user's constant attention being required at the UI 26. Using the shared sound environment of this invention, however, the game ball can be represented by a sound of any desired complexity, which releases the users from having to constantly view the display 10D of the UI 26.

As an example of a volleyball application, the game is started by one of the group members who may choose the difficulty level and accept other members of a group to join the game. Each member is given a player number that corresponds to a number on the keypad 10C. The different player numbers can be displayed on the display 10D, or voice synthesis could be used for informing the players of their player number and the numbers of other players. The keypad 10C is used to aim a shot towards one of the players by depressing the recipient player's keypad number. The ball is represented by a sound having a base pitch that represents an ideal moment to hit the ball. Horizontal ball movement (horizontal component) may be represented by a volume change, and vertical ball movement (vertical component) may be represented by a pitch change, as depicted in FIG. 6 and described above. In addition, another sound may be used to represent a player making contact with the virtual volleyball.

The players can hit the ball towards any of the other players by pressing the corresponding number on the keypad. The closer to the base pitch that the key is pressed, the more force is used to hit the ball. If the sound goes below the base pitch before a player hits the virtual ball, the player has missed the ball. A player can lose a point or the game by pressing the key of a player who is out of the game, or one that is not assigned to any player.

The foregoing two gaming applications are intended to be merely representative of the utility of this invention, and are in no way to be viewed as limitations on the use of the invention. In these and other gaming applications, those skilled in the game programming arts are assumed to have written software that is executed by the mobile stations 10 for simulating the physical motion in the game space of the moving virtual object or objects. The specifics of the play of the game are not germane to an understanding of this invention, except as to the use of the shared sound environment for representing at least one of the location, motion, velocity, trajectory, impact, etc. of the moving object or objects, as described above.

As a further example of the utility of this invention, and as was noted previously, graphical user interfaces are typically employed to inform a user of a status of a data moving or copying operation. The shared sound environment of this invention can be applied also in this case to replace or supplement the traditional graphical interface. For example, the sound “movement” is used to illustrate the progress of the data moving or copying application. When the action is about to begin, the sound is played only by the source mobile station 10 (e.g., MS_A of FIGS. 5 and 6). When the action is completed, the sound is played only by the destination mobile station 10 (MS_B of FIGS. 5 and 6). Pitch bending and/or different notes can also be used to illustrate the structure of the data being moved. For example, when multiple compact files are copied, the sound may be made to vary more than would be the case with larger data files. Further additions can be made that are useful for visually impaired users—various options that are usually presented visually on a screen may be represented as sounds; a “dialog box” that presents the user with a choice of options may be represented with a first sound, the options could be represented by pitch bending, etc.

In this embodiment, then, the “object” of FIGS. 5 and 6 is not a game piece per se, but represents a data object that is being moved over a wireless link from MS_A to MS_B (and possibly other destination mobile stations 10 as well.) The data object need not be a file, but could also be a text message composed on the keypad 10C of MS_A and transmitted to MS_B for display on the display 10D. Simultaneously with the transmission of the message the sound is transmitted and controlled to inform the users of the progress of the sending and arrival of the message.

The invention can also be applied to playing music. In the case of a group playing the same composition, the data representing the music may contain an indication of which instrument is playing the melody at any moment (or that has a solo) and the software controlling the playing would increase the volume of the device playing that part. In another embodiment, the music could represent a moving group of musicians, with the sound from several playing devices being controlled to represent the motion.

The teachings of this invention thus employ sound to express the location of an object or the status of transferring data in relation to members of a group of mobile stations 10. The teachings of this invention also enable applications to communicate with one other using sound (for example, two virtual electronic “pets” residing in two mobile stations sense each others presence and begin a conversation).

Thus, while described in the context of certain presently preferred embodiments, the teachings in accordance with this invention are not limited to only these embodiments. For example, the wireless connection between terminals 10 can be any suitable type of low latency RF or optical connection so long as it exhibits the bandwidth required to convey MIDI (or similar file type) messages between the participating mobile stations.

What is claimed is:

1. A method for operating at least two mobile stations that form a local group of mobile stations, comprising:
beginning an application with each of the mobile stations; and
using a variation in sound made by each of the mobile stations to represent a virtual object that moves between the mobile stations during execution of the application.

2. A method as in claim 1, where the application comprises a game, and where the virtual object comprises a game piece

3. A method as in claim 1, where the application comprises a transfer of data, and where the virtual object comprises data.

4. A method as in claim 1, where the step of beginning the application includes a step of assigning a unique identifier to each of the mobile stations during an application enrollment step.

5. A method as in claim 4, where the unique identifier corresponds to a MIDI channel number.

6. A method as in claim 1, where the variation in sound is caused by execution of MIDI commands that change in a linear manner or in a non-linear manner the volume of the sound made by the mobile stations.

7. A method as in claim 1, where the variation in sound is caused by execution of MIDI commands that change in a linear manner or in a non-linear manner the pitch of the sound made by the mobile stations.

8. A method as in claim 1, where the variation in sound in one of the mobile stations is made in response to MIDI commands received through a wireless interface from another mobile station.

9. A method as in claim 1, where the movement of the virtual object has both a horizontal component and a vertical component, and where the sound is separately varied to represent changes in object motion in both the horizontal and vertical components

10. A system comprised of at least two mobile stations that form a local group of mobile stations, each of the mobile stations being programmed for beginning an application and for using a variation in sound made by each of the mobile stations to represent a virtual object that moves between the mobile stations during execution of the application.

11. A system as in claim 10, where the application comprises a game, and where the virtual object comprises a game piece.

12. A system as in claim 10, where the application comprises a transfer of data, and where the virtual object comprises data.

13. A system as in claim 10, where at the beginning of the application a unique identifier is assigned to each of the mobile stations.

14. A system as in claim 13, where the unique identifier corresponds to a MIDI channel number.

15. A system as in claim 10, where the variation in sound is caused by execution of MIDI commands that change in a linear manner or in a non-linear manner the volume of the sound made by the mobile stations.

16. A system as in claim 10, where the variation in sound is caused by execution of MIDI commands that change in a linear manner or in a non-linear manner the pitch of the sound made by the mobile stations.

17. A system as in claim 10, where the variation in sound in one of the mobile stations is made in response to MIDI commands received through a wireless interface from another mobile station.

18. A system as in claim 10, where the movement of the virtual object has both a horizontal component and a vertical component, and where the sound is separately varied to represent changes in object motion in both the horizontal and vertical components.

19. A mobile station, comprising a wireless transceiver coupled to a MIDI controller and a MIDI synthesizer that has an output coupled to a speaker, said MIDI controller being responsive to received MIDI commands from another mobile station for varying a sound made by the speaker so as to represent a motion of a virtual object between mobile stations.

20. A mobile station as in claim 19, where said wireless transceiver comprises a Bluetooth transceiver.

21. A mobile station comprising an audio user interface (AUI) for representing to a user a motion of a data object relative to the mobile station, the motion being represented by a variation in an audio output of the mobile station.

22. A computer system comprising a wireless transceiver coupled to a MIDI controller and a MIDI synthesizer that has an output coupled to a speaker, said MIDI controller being responsive to received MIDI commands from another computer system for varying a sound made by the speaker so as to represent a motion of a virtual object between computer systems.

23. A computer system as in claim 22, where said wireless transceiver comprises a Bluetooth transceiver.

24. A computer system having an audio user interface (AUI) for representing to a user the motion of a data object relative to the mobile station, the motion being represented by a variation in an audio output of the computer system.
